(19) United States
(12) Patent Application Publication
(10) Pub. No.: US 2026/0014835 A1
(43) Pub. Date: Jan. 15, 2026

(54) OIL ACCUMULATION ELIMINATING DEVICE

(71) Applicant: Panasonic Automotive Systems Co., Ltd., Kanagawa (JP)

(72) Inventor: Tomohiro TERADA, Kanagawa (JP)

(73) Assignee: Panasonic Automotive Systems Co., Ltd., Kanagawa (JP)

(21) Appl. No.: 19/259,417

(22) Filed: Jul. 3, 2025

(30) Foreign Application Priority Data
Jul. 9, 2024 (JP) 2024-110202

(51) Int. Cl. B60H 1/32; B60H 1/00; B60L 53/302

(52) U.S. Cl. CPC B60H 1/3228; B60H 1/00271; B60H 1/00328; B60L 53/302

(57) ABSTRACT

An oil accumulation eliminating device includes: a cooling plate that includes a housing thermally connected to a heat dissipation target, an inflow port connected to high-pressure side piping in an air-conditioning system through which a refrigerant circulates, and supplied with the refrigerant from the high-pressure side piping, a flow passage that is formed inside the housing, and though which the refrigerant that has flowed in from the inflow port flows, an outflow port that is connected to low-pressure side piping of the air-conditioning system, and ejects, to the low-pressure side piping, the refrigerant that has exchanged heat with the housing in the flow passage; and return pipe that spatially connects, outside the housing of the cooling plate, the inflow port and the outflow port of the cooling plate by using a flow passage section that is smaller than flow passage sections of the inflow port and the outflow port.

### CROSS-REFERENCE TO RELATED APPLICATIONS

This application is based upon and claims the benefit of priority from Japanese Patent Application No. 2024-110202, filed Jul. 9, 2024, the entire contents of which are incorporated herein by reference.

### FIELD

The present disclosure relates to an oil accumulation eliminating device.

### BACKGROUND

Conventionally, in power conversion devices, such as on-board chargers or DCDC converters, that are mounted on electric vehicles or the like, power conversion is performed on power of a large current or a high voltage. Such power conversion devices are reduced in size as their control frequency increases, but there has been a problem of heat dissipation from a mounted heat generating component.

For example, JP 6014602 B2 discloses a technique for connecting a battery module to a heat exchanger via a coolant circulating circuit, connecting the heat exchanger to a temperature control device via a refrigerant circulating circuit, cooling down a refrigerant in the refrigerant circulating circuit by using a cooling function of the temperature control device, and exchanging heat between the refrigerant in the refrigerant circulating circuit and the coolant in the coolant circulating circuit in the heat exchanger to cool down the battery module by using the coolant in the coolant circulating circuit.

For example, a heat generating component serving as a heat dissipation target is disposed on a plate-like heat exchanger (a cooling plate) in which a flow passage has been formed, and cooling is performed in some cases. In such cases, from the viewpoint of achieving improvements in the cooling capability using the cooling plate, it is preferable that a refrigerant that can use latent heat in a phase change, instead of a liquid coolant such as water, be used as a working fluid. However, in cooling-down using the refrigerant as a working fluid, compressor oil circulates together with the refrigerant, and this has caused a problem in which oil is likely to be accumulated in the flow passage of the cooling plate having a large pressure loss.

An object of the present disclosure is to prevent compressor oil that circulates together with a refrigerant from being stagnant inside a cooling plate.

### SUMMARY

An oil accumulation eliminating device according to the present disclosure includes a cooling plat, and a return pipe. The cooling plate includes a housing, an inflow port, a flow passage, and an outflow port. The housing is thermally connected to a heat dissipation target. The inflow port that is connected to high-pressure side piping in an air-conditioning system through which a refrigerant circulates, and supplied with the refrigerant from the high-pressure side piping. The flow passage is formed inside the housing, and though which the refrigerant that has flowed in from the inflow port flows. The outflow port is connected to low-pressure side piping of the air-conditioning system, and ejects, to the low-pressure side piping, the refrigerant that has exchanged heat with the housing in the flow passage. The return pipe spatially connects, outside the housing of the cooling plate, the inflow port and the outflow port of the cooling plate by using a flow passage section that is smaller than flow passage sections of the inflow port and the outflow port.

### BRIEF DESCRIPTION OF THE DRAWINGS

FIG. 1 is a diagram illustrating an example of a configuration of a cooling system according to an embodiment;

FIG. 2 is a perspective view illustrating an example of a configuration of the cooling plate of FIG. 1;

FIG. 3 is a diagram illustrating an example of an internal configuration of the cooling plate of FIG. 1;

FIG. 4 is a diagram illustrating an example of a configuration of an oil accumulation eliminating device that has been applied to the cooling plate of FIG. 1;

FIG. 5 is a diagram illustrating an example of a configuration of the oil accumulation eliminating device of FIG. 4;

FIG. 6 is a diagram illustrating another example of the configuration of the oil accumulation eliminating device of FIG. 4;

FIG. 7 is a diagram illustrating another example of the configuration of the oil accumulation eliminating device that has been applied to the cooling plate of FIG. 1;

FIG. 8 is a diagram illustrating an example of a configuration of a relay block of the oil accumulation eliminating device of FIG. 7; and

FIG. 9 is a diagram illustrating an example of the configuration of the relay block of the oil accumulation eliminating device of FIG. 7.

### DETAILED DESCRIPTION

Embodiments of an oil accumulation eliminating device, a cooling device, a power conversion device, and a vehicle according to the present disclosure are described below with reference to the drawings.

Note that in the description of the present disclosure, a component that has the same or roughly the same function as a function of a component described with reference to an already described drawing is denoted by the same reference sign, and description is appropriately omitted in some cases. Furthermore, even in a case where the same or roughly the same portion is indicated, the portion is indicated to have dimensions or a ratio that change(s) depending on the drawings in some cases. Furthermore, for example, from the viewpoint of securing visibility of the drawings, in the description of each of the drawings, only principal components are denoted by reference signs, and even a component that has the same or roughly the same function as a function of a component described with reference to an already described drawing is not denoted by a reference sign in some cases.

Note that in the description of the present disclosure, an expression such as “orthogonal”, “horizontal”, “vertical”, “parallel”, “same”, “match”, or “same position” is not strictly limited to the case of “orthogonal”, “horizontal”, “vertical”, “parallel”, “same”, “match”, or “same position”, and covers a case that can be regarded as “orthogonal”, “horizontal”, “vertical”, “parallel”, “same”, “match”, or “same position”.

### First Embodiment

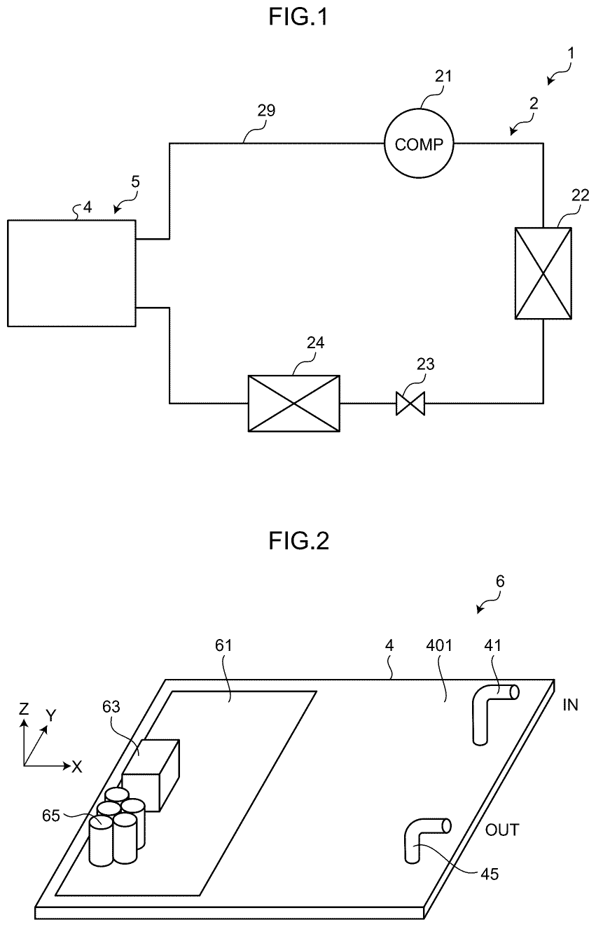

FIG. 1 is a diagram illustrating an example of a configuration of a cooling system 1 according to an embodiment. The cooling system 1 according to the embodiment is applied to, for example, a vehicle (a moving body), and is a system configured to be able to cool down a heat generator of the vehicle.

The cooling system 1 according to the embodiment is applied to an air-conditioning system 2 that is mounted on, for example, a vehicle. As illustrated in FIG. 1, the air-conditioning system 2 includes a compressor 21, a condenser 22, an expansion valve 23, an evaporator 24, and piping 29.

The compressor 21 is equipment (a compressor) that adiabatically compresses a refrigerant that circulates through the piping, and generates and discharges a refrigerant (gas) having high temperature and high pressure. The compressor 21 may be of a water-cooled type, or may be of an air-cooled type. Note that the compressor 21 is, for example, an oil-injected type compressor, and a discharged refrigerant (gas) contains oil mist. Stated another way, in the cooling system 1 according to the embodiment, a refrigerant circulates through the piping 29 together with compressor oil.

The condenser 22 is provided in a post-stage of the compressor 21, and is a heat exchanger (a condenser) that dissipates heat of the refrigerant (gas) having high temperature and high pressure from the compressor 21 and condenses the refrigerant to liquefy the refrigerant. Note that the condenser 22 may be of an air-cooled type, may be of a water-cooled type, or may be of an evaporation type.

The expansion valve 23 is provided in a post-stage of the condenser 22, and is equipment (a throttle valve) that adiabatically compresses (decompresses and expands) a refrigerant (liquid) having high pressure from the condenser 22, and stated another way, adiabatically cools down the refrigerant to generate a refrigerant (gas/liquid) having low temperature and low pressure. Note that a refrigerating cycle that implements the air-conditioning system 2 may be configured as a cycle that can recover some power by using, as the expansion valve 23, an expander of a displacement type or a turbine type.

The evaporator 24 is provided in a post-stage of the expansion valve 23, and is a heat exchanger (an evaporator) that vaporizes the refrigerant (gas/liquid) having low temperature and low pressure from the expansion valve 23. Note that the evaporator 24 may be of an air-cooled type, may be of a water-cooled type, or may be of an evaporation type. Furthermore, the evaporator 24 may be a dry type evaporator at an outlet of which the refrigerant has completely changed into gas, or may be a flooded evaporator that causes a liquid refrigerant to be always present in the evaporator 24.

The piping 29 is a flow passage that connects the compressor 21, the condenser 22, the expansion valve 23, and the evaporator 24, and that a refrigerant circulates through.

In the present embodiment, the air-conditioning system 2 that has at least a cooling function is described as an example, but this is not restrictive. The air-conditioning system 2 may have a heating function in addition to the cooling function. For example, the air-conditioning system 2 achieves a cooling function for cooling down air in a vehicle cabin by using heat absorption in the evaporator 24, and the air-conditioning system 2 may achieve a heating function for heating air in the vehicle cabin by using heat dissipation in the condenser 22, and stated another way, by causing the condenser 22 to operate as a heat pump.

Note that in the air-conditioning system 2, an oil separator that separates oil from a refrigerant gas that has been discharged from the compressor 21 may be provided in a post-stage of the compressor 21. Furthermore, inside or in a post-stage of the condenser 22, a receiver (a liquid receiver) that absorbs variations in an amount of a refrigerant in the piping 29 may be provided.

Note that the air-conditioning system 2 according to the embodiment may include a plurality of compressors 21 or expansion valves 23 in accordance with, for example, a requested cooling capability.

In the air-conditioning system 2 according to the embodiment, as a refrigerant, for example, hydrofluorocarbon (HFC), such as R410A or R32, is used, but hydrofluoroolefin (HFO) such as HFO-1234yf, CO2, or the like may be used.

Note that the cooling system 1 according to the embodiment may be configured as a system that is independent of the air-conditioning system 2 that is mounted on a vehicle or the like. Alternatively, the cooling system 1 according to the embodiment may be configured as a system that shares at least one of the compressor 21, the condenser 22, the expansion valve 23, the evaporator 24, and the piping 29.

Furthermore, as illustrated in FIG. 1, a cooling plate 4 is included. The cooling plate 4 is provided, for example, between the evaporator 24 and the compressor 21, and is connected to each of the evaporator 24 and the compressor 21 by using the piping 29. Stated another way, in the cooling system 1 that has been applied to the air-conditioning system 2, a refrigerant circulates through the piping 29 in the order of the compressor 21->the condenser 22->the expansion valve 23->the evaporator 24->the cooling plate 4->the compressor 21.

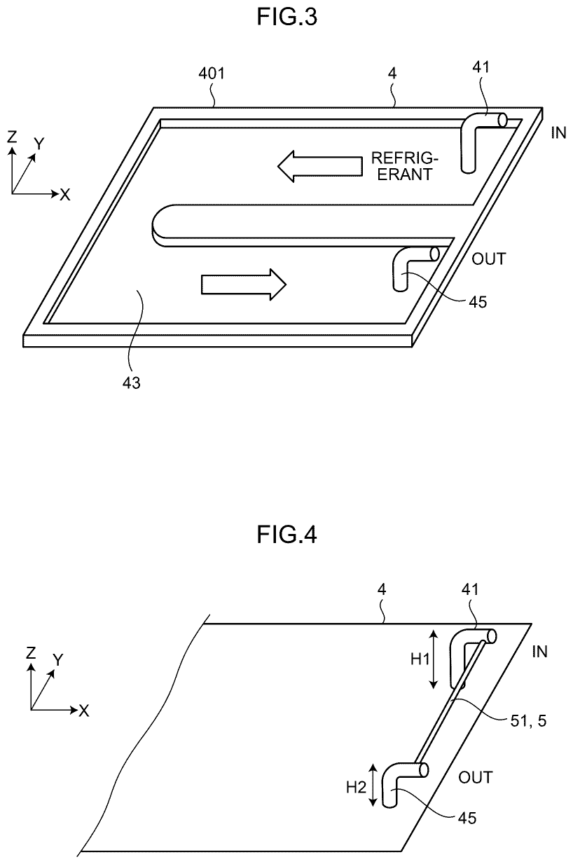

FIG. 2 is a perspective view illustrating an example of a configuration of the cooling plate 4 of FIG. 1. FIG. 3 is a diagram illustrating an example of an internal configuration of the cooling plate 4 of FIG. 1.

The cooling plate 4 is a cooling member that has been formed in a plate shape by using a metal material such as a die cast product. The cooling plate 4 has a cooling structure that uses, as a working fluid, a refrigerant that circulates through the air-conditioning system 2.

Specifically, the cooling plate 4 has a cooling structure that cools down a cooling target (a heat dissipation target) that is thermally connected to a housing 401 of the cooling plate 4. As illustrated in FIGS. 2 and 3, the cooling plate 4 includes an inflow port 41, a flow passage 43, and an outflow port 45.

The inflow port 41 is connected to the outlet of the evaporator 24 via the piping 29. The inflow port 41 connects the piping 29 to the flow passage 43 of the cooling plate 4. The inflow port 41 is supplied with a refrigerant from the evaporator 24.

The flow passage 43 is a refrigerant flow passage that has been formed inside the housing 401. The flow passage 43 extends in a direction along a cooling surface (an X-Y plane) of the cooling plate 4. Stated another way, inside the housing 401 of the cooling plate 4, the flow passage 43 that runs in one plane along the cooling surface has been formed. A flow passage shape on a plane that is orthogonal to a flow of the flow passage 43 is different from a shape of, for example, the piping 29, the inflow port 41, or the outflow port 45.

Note that the flow passage 43 may branch in at least two directions in the one plane along the cooling surface. On the other hand, the flow passage does not branch in a direction (a Z direction) that is orthogonal to the cooling surface. Stated another way, in a case where at least flow passages of two directions are provided as the flow passage 43, and there is a crossing portion where the flow passages of the two directions cross each other, each of the flow passages extends from the crossing portion in a direction that is parallel to the cooling surface, but does not extend in the direction that is orthogonal to the cooling surface. As described above, in the cooling plate 4 according to the present disclosure, the flow passage 43 that only runs in one plane inside the housing 401 forms a mechanism that cools down the entirety of a system.

Note that in the cooling system 1 according to the present disclosure, a direction (an X direction and a Y direction) along the cooling surface is, for example, a horizontal direction. Furthermore, the direction (the Z direction) that is orthogonal to the cooling surface is, for example, a gravity direction. Needless to say, these respective directions are examples, and the Z direction may have an inclination relative to the gravity direction. Alternatively, either the X direction or the Y direction may be the gravity direction.

The outflow port 45 is connected to an inlet of the compressor 21 via the piping 29. The outflow port 45 connects the piping 29 to the flow passage 43 of the cooling plate 4. A refrigerant that has passed through the flow passage 43 of the cooling plate 4 is ejected from the outflow port 45, and is supplied to the compressor 21.

As an example, in the cooling system 1 that has been applied to a vehicle, the housing 401 of the cooling plate 4 is thermally connected to a heat generator of the vehicle, and transfers heat from the heat generator of the vehicle via the refrigerant to an outside of the cooling plate 4.

FIG. 2 illustrates a case where an on-board charger 6 serving as the heat generator of the vehicle is disposed in the housing 401. In the example of FIG. 2, a substrate 61 of the on-board charger 6, and a transformer 63 and an electrolytic capacitor 65 that are disposed on the substrate 61 are thermally connected to the housing 401. Note that the transformer 63 and the electrolytic capacitor 65 may be thermally connected to the cooling plate 4 with the substrate 61 interposed therebetween, or may be thermally and directly connected to the cooling plate 4 without the substrate 61 interposed therebetween.

Note that the heat generator of the vehicle is a power conversion device such as an on-board charger or a DCDC converter, but may be a battery, electric equipment, or the like. Furthermore, the power conversion device is not necessarily mounted on a vehicle (a moving body) such as an electric vehicle, and may be mounted on a device that is different from the moving body, such as a charging device of a charging station, a game facility, or an uninterruptible power supply device. For example, the on-board charger may be a power conversion device that converts AC power supplied from a single-phase or three-phase AC power supply outside the vehicle into DC power, and supplies the DC power after conversion to a load that is mounted on the vehicle. This load may be, for example, a battery, an inverter, a motor, or various pieces of electric equipment.

Note that conceivable examples of the moving body to which the cooling system 1 according to the present disclosure is applied include passenger cars, freight cars, busses, motorcycles, electric scooters, construction machines, agricultural machines, airplanes, and the like.

Furthermore, conceivable examples of the electric equipment of the moving body include navigation devices, audio equipment, air-conditioners, power windows, defoggers, electronic control units (ECUs), global positioning system (GPS) modules, cameras, and the like.

Furthermore, it is sufficient if the battery of the moving body can store power for driving a motor for movement (a traction motor), electric equipment, or the like that is mounted on the moving body, and an arbitrary battery, such as a lithium-ion battery, a nickel-hydrogen battery, or a solid-state battery, can be appropriately used.

For example, the on-board charger may be provided with a noise filter that prevents noise from entering from an external AC power supply to the on-board charger, and prevents noise from flowing out from the on-board charger to the AC power supply (removes noise). Furthermore, for example, in a post-stage of the noise filter, a power conversion circuit that converts, into DC power, AC power that has been supplied from an external single-phase or three-phase AC power supply via the noise filter, and outputs the DC power after conversion to a battery, is provided. This power conversion circuit is provided with, for example, a power factor correction (PFC) circuit that rectifies and smooths an AC voltage from the external AC power supply after causing the noise filter to remove noise, and generates a DC voltage. Furthermore, for example, in a post-stage of the PFC circuit in the power conversion circuit, a DC-DC conversion circuit (the DCDC converter) that again converts the DC voltage generated by the PFC circuit into the AC voltage, and then rectifies and smooths the AC voltage to generate a DC voltage having an arbitrarily set voltage, is provided.

Respective units of the on-board charger, such as the noise filter, the PFC circuit, or the DC-DC conversion circuit, include a magnetic component, such as a transformer, a transformer integrated printed board, various inductors such as a choke, a reactor, or an assembly including them. A coil device that is mounted with the magnetic component, such as the on-board charger, the noise filter, the PFC circuit, or the DC-DC conversion circuit (the DCDC converter), significantly generates heat, when power conversion is performed on power of a large current or a high voltage. Such a coil device or the magnetic component of the coil device are examples of a cooling target (a heat dissipation target) of the cooling system 1 according to the present disclosure, and are examples of the heat generator of the vehicle.

For example, in a case where a heat generating component serving as a heat dissipation target is disposed on the cooling plate 4 in which the flow passage 43 has been formed, and cooling is performed, from the viewpoint of achieving improvements in the cooling capability using the cooling plate 4, it is preferable that a refrigerant that can use latent heat in a phase change be used as a working fluid. However, in cooling-down using the refrigerant as a working fluid, compressor oil circulates together with the refrigerant, and this has caused a problem in which oil is likely to be accumulated in the flow passage 43 of the cooling plate 4 along with a decrease in pressure or a decrease in flow velocity due to a pressure loss, or the routing of the flow passage 43.

Furthermore, the flow passage 43 that is provided for cooling has been increased along, for example, the cooling surface (the X-Y plane) in order to increase the heating area of the flow passage 43. Alternatively, in order to increase a length in the cooling plate 4, the flow passage 43 has been routed in the cooling plate 4, for example, with a flow passage section reduced. As described above, a shape of the flow passage 43 is different from a shape of, for example, the piping 29, the inflow port 41, or the outflow port 45, on a plane that is orthogonal to a flow. Therefore, there has been a problem in which oil is likely to be accumulated in the flow passage 43 of the cooling plate 4 along with a decrease in pressure or a decrease in flow velocity due to a pressure loss, or the routing of the flow passage 43.

Furthermore, an amount of oil (a circulation amount) of the compressor oil that circulates together with the refrigerant has been set in such a way that a certain amount of oil remains in the compressor 21. Therefore, if oil is stagnant in the cooling plate 4, a circulation amount decreases, and there is a possibility of the occurrence of seizure in the compressor 21. On the other hand, if the circulation amount has been set large, the energy required for circulation increases, and there is a possibility of an increase in power consumption or a deterioration in cooling efficiency.

In view of the above, the cooling system 1 according to the present disclosure is provided with an oil accumulation eliminating device 5 that prevents the compressor oil that circulates together with the refrigerant from being stagnant inside the cooling plate 4.

Specifically, in the cooling system 1 according to the present disclosure, the oil accumulation eliminating device 5 has been applied to the cooling plate 4.

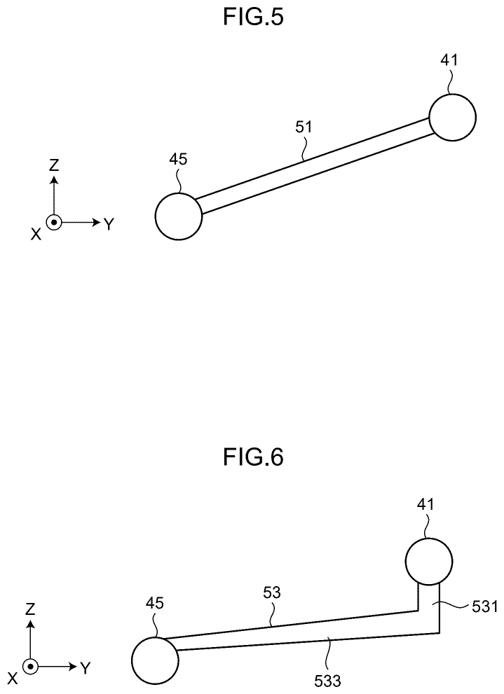

FIG. 4 is a diagram illustrating an example of a configuration of the oil accumulation eliminating device 5 that has been applied to the cooling plate 4 of FIG. 1. FIG. 5 is a diagram illustrating an example of a configuration of the oil accumulation eliminating device 5 of FIG. 4.

As illustrated in FIGS. 4 and 5, the oil accumulation eliminating device 5 according to the present embodiment includes a return pipe 51. The return pipe 51 connects the inflow port 41 and the outflow port 45.

As illustrated in FIG. 4, a length H1 by which the inflow port 41 protrudes from the housing 401 in the Z direction of protrusion is greater than a length H2 by which the outflow port 45 protrudes from the housing 401 in the Z direction. Stated another way, the inflow port 41 is located above the outflow port 45, for example, in the gravity direction (the Z direction).

The inflow port 41 and the outflow port 45 have a pipe diameter of, for example, about 13 to 16 mm. Each of a side closer to the outflow port 45 in the inflow port 41 and a side closer to the inflow port 41 in the outflow port 45 is provided with a hole having a diameter of, for example, about 1 to 3 mm.

The return pipe 51 is connected to the holes of the inflow port 41 and the outflow port 45 by performing, for example, brazing. The return pipe 51 is a pipe line that has a flow passage section having a diameter of, for example, about 1 to 3 mm. Therefore, the return pipe 51 spatially connects the inflow port 41 to the outflow port 45 by using a cross-sectional area that is smaller than cross-sectional areas of respective pipe lines.

Note that the return pipe 51 has, for example, a circular cross-sectional shape, but may have another cross-sectional shape such as an ellipse or a rectangle.

By doing this, oil is pushed out from the inflow port 41 of a high-pressure side to the outflow port 45 of a low-pressure side. The oil that has been pushed out to the outflow port 45 is ejected to the outside of the cooling plate 4 together with the refrigerant that flows out from the flow passage 43.

As described above, by employing the cooling plate 4 to which the oil accumulation eliminating device 5 has been applied, oil is sucked out from the inflow port 41 to the outflow port 45, and this can reduce an amount of compressor oil that flows into the flow passage 43. Stated another way, the cooling system 1 according to the embodiment can prevent compressor oil that circulates together with the refrigerant from being stagnant inside the cooling plate 4.

Another embodiment of the cooling system 1 according to the present disclosure is described below with reference to the drawings. In the description below, a difference from the embodiment described above is principally described, and a duplicate description is appropriately omitted.

### Second Embodiment

Note that a configuration of the oil accumulation eliminating device 5 is not limited to the example of FIG. 5, and can be appropriately changed. FIG. 6 is a diagram illustrating another example of the configuration of the oil accumulation eliminating device 5 of FIG. 4.

As illustrated in FIG. 6, an oil accumulation eliminating device 5 according to the present embodiment includes a return pipe 53. The return pipe 53 connects the inflow port 41 and the outflow port 45.

Each of a lower portion in the gravity direction (the −Z side) in the inflow port 41 and a side closer to the inflow port 41 in the outflow port 45 is provided with a hole having a diameter of, for example, about 1 to 3 mm. The return pipe 53 is connected to the holes of the inflow port 41 and the outflow port 45 by performing, for example, brazing. The return pipe 53 is a pipe line that has a flow passage section having a diameter of, for example, about 1 to 3 mm. Therefore, the return pipe 53 spatially connects the inflow port 41 to the outflow port 45 by using a cross-sectional area that is smaller than cross-sectional areas of respective pipe lines, similarly to the return pipe 51.

As illustrated in FIG. 6, the return pipe 53 includes an oil trap 531 and a pipe line 533.

The oil trap 531 is provided below the inflow port 41 in the gravity direction (the −Z side). The oil trap 531 is formed by, for example, a pipe line that extends downward from the hole that is provided in the lower portion (the −Z side) in the gravity direction in the inflow port 41. The pipe line 533 spatially connects a lower portion (the −Z side) in the gravity direction in the oil trap 531 to the hole of the outflow port 45. The pipe line 533 has been formed to have a flow passage section decreasing toward the outflow port 45 from the oil trap 531.

Note that each of the oil trap 531 and the pipe line 533 has, for example, a circular cross-sectional shape, but may have another cross-sectional shape such as an ellipse or a rectangle.

Note that the oil trap 531 may be formed to have a flow passage section decreasing downward in the gravity direction (toward the −Z side) from the hole of the inflow port 41.

Note that the flow passage section of the pipe line 533 decreases, for example, in a uniform manner, in a portion closer to the outflow port 45 from the oil trap 531, but this is not restrictive. A portion or the entirety of the pipe line 533 may have a fixed flow passage section similarly to the return pipe 51.

In this configuration, similarly, oil can be sucked from the inflow port 41 of the high-pressure side to the outflow port 45 of the low-pressure side, and an amount of compressor oil that flows into the flow passage 43 can be reduced.

Furthermore, according to the configuration in which the oil trap 531 is provided under the inflow port 41 in accordance with oil falling in the gravity direction, oil can be efficiently ejected from the inflow port 41 of the high-pressure side.

Furthermore, according to the configuration in which the inflow port 41 and the outflow port 45 are spatially connected by the pipe line 533 having a flow passage section gradually decreasing, oil is easily pushed out to the outflow port 45, and this enables a further reduction in an amount of compressor oil that flows into the flow passage 43.

Note that the oil accumulation eliminating device 5 according to the present embodiment can be applied to the cooling system 1 according to the first embodiment. For example, in the cooling plate 4 according to the first embodiment, the return pipe 51 may be formed to have a flow passage section decreasing toward the outflow port 45 from the inflow port 41, similarly to the pipe line 533 of the oil accumulation eliminating device 5 according to the second embodiment.

### Third Embodiment

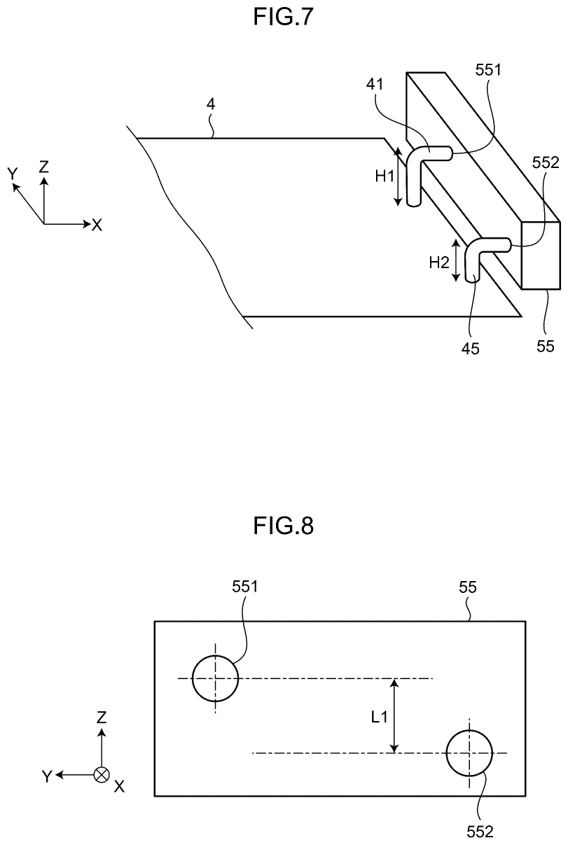

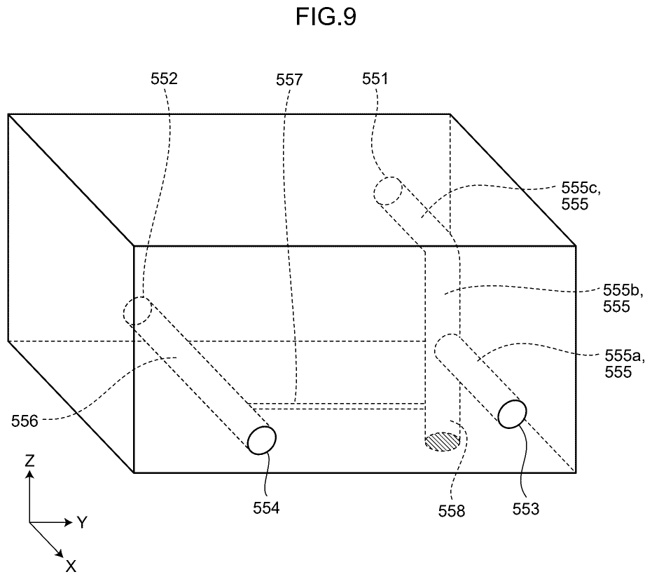

Note that a configuration of the oil accumulation eliminating device 5 is not limited to the examples of FIGS. 5 and 6, and can be appropriately changed. FIG. 7 is a diagram illustrating another example of the configuration of the oil accumulation eliminating device 5 that has been applied to the cooling plate 4 of FIG. 1. FIG. 8 is a diagram illustrating an example of a configuration of a relay block 55 of the oil accumulation eliminating device 5 of FIG. 7. FIG. 9 is a diagram illustrating an example of the configuration of the relay block 55 of the oil accumulation eliminating device 5 of FIG. 7.

As illustrated in FIG. 7, an oil accumulation eliminating device 5 according to the present embodiment includes a relay block 55. The relay block 55 has, for example, a rectangular parallelopiped shape. A structure that is similar to a structure of, for example, the return pipe 53 has been formed inside the relay block 55.

As illustrated in FIG. 7, the relay block 55 is connected to the cooling plate 4. Specifically, the relay block 55 includes an inflow-port side connection unit 551 that is connected to the inflow port 41 of the cooling plate 4, and an outflow-port side connection unit 552 that is connected to the outflow port 45 of the cooling plate 4.

As illustrated in FIG. 8, the inflow-port side connection unit 551 and the outflow-port side connection unit 552 are provided, for example, on one surface (a Y-Z plane on a −X side) of the relay block 55. The inflow-port side connection unit 551 and the outflow-port side connection unit 552 are different from each other in a position in the gravity direction (the Z direction) in the relay block 55. Specifically, the inflow-port side connection unit 551 and the outflow-port side connection unit 552 are different from each other in the position in the gravity direction (the Z direction) by a length Li of a difference between lengths H1 and H2 by which the inflow port 41 and the outflow port 45 of the cooling plate 4 protrude from the housing 401 in the Z direction in accordance with the lengths H1 and H2.

As illustrated in FIG. 9, a relay-block side inflow port 553 is provided on a surface (a Y-Z plane) on an opposite side (a +X side) of the inflow-port side connection unit 551 of the relay block 55. The relay-block side inflow port 553 is connected to the outlet of the evaporator 24 via the piping 29. The relay-block side inflow port 553 is supplied with a refrigerant from the evaporator 24. Inside the relay block 55, the inflow-port side connection unit 551 and the relay-block side inflow port 553 are spatially connected by an inflow side flow passage 555. Stated another way, the relay block 55, together with the inflow port 41 of the cooling plate 4, connects the piping 29 to the flow passage 43 of the cooling plate 4.

As illustrated in FIG. 9, the inflow side flow passage 555 includes a first flow passage 555a, a second flow passage 555b, and a third flow passage 555c. The first flow passage 555a is a flow passage that extends from the relay-block side inflow port 553 to the second flow passage 555b in a −X direction inside the relay block 55. The second flow passage 555b is a flow passage that extends in the gravity direction (the Z direction) inside the relay block 55. The second flow passage 555b is spatially connected to an end located on a −X side in the first flow passage 555a inside the relay block 55. The third flow passage 555c is a flow passage that extends from the inflow-port side connection unit 551 to the second flow passage 555b in a +X direction inside the relay block 55. The third flow passage 555c is spatially connected to an end located on an upper side in the gravity direction (the Z direction) in the second flow passage 55ab inside the relay block 55. In other words, the second flow passage 555b is spatially connected to an end located on the +X side in the third flow passage 555c inside the relay block 55. In yet other words, the second flow passage 555b spatially connects the first flow passage 555a and the third flow passage 555c inside the relay block 55.

Similarly, a relay-block side outflow port 554 is provided on the surface (the Y-Z plane) located on an opposite side (the +X side) of the outflow-port side connection unit 552 of the relay block 55. The relay-block side outflow port 554 is connected to the inlet of the compressor 21 via the piping 29. Inside the relay block 55, the outflow-port side connection unit 552 and the relay-block side outflow port 554 are spatially connected by an outflow side flow passage 556. The outflow side flow passage 556 is a flow passage that extends from the outflow-port side connection unit 552 to the relay-block side outflow port 554 in the +X direction inside the relay block 55. Stated another way, the relay block 55, together with the outflow port 45 of the cooling plate 4, connects the piping 29 to the flow passage 43 of the cooling plate 4. A refrigerant that has passed through the flow passage 43 of the cooling plate 4 is ejected via the relay block 55, and is supplied to the compressor 21.

The inflow-port side connection unit 551, the outflow-port side connection unit 552, the relay-block side inflow port 553, and the relay-block side outflow port 554 have, for example, a pipe diameter that is the same as a pipe diameter of the inflow port 41 and the outflow port 45. Furthermore, a hole having a diameter of, for example, about 1 to 3 mm is provided on each of a side closer to the outflow side flow passage 556 under a portion connecting to the first flow passage 555a in the second flow passage 555b (the inflow side flow passage 555) and a side closer to the second flow passage 555b (the inflow side flow passage 555) in the outflow side flow passage 556.

As illustrated in FIG. 9, a return pipe 557 has been formed inside the relay block 55. The return pipe 557 is connected to the holes of the inflow side flow passage 555 and the outflow side flow passage 556. The return pipe 557 is a pipe line that has a flow passage section having a diameter of, for example, about 1 to 3 mm. Therefore, the return pipe 557 spatially connects the inflow side flow passage 555 to the outflow side flow passage 556 by using a cross-sectional area that is smaller than cross-sectional areas of respective pipe lines.

Note that the return pipe 557 has, for example, a circular cross-sectional shape, but may have another cross-sectional shape such as an ellipse or a rectangle. Note that the return pipe 557 has a configuration that is similar to, for example, a configuration of the return pipe 51 according to the first embodiment, but may have a configuration that is similar to a configuration of the return pipe 53 according to the second embodiment.

As illustrated in FIG. 9, an oil trap 558 has been formed on a lower side in the gravity direction (the Z direction) in the second flow passage 555b. As an example, the oil trap 558 is a portion of a pipe line that forms a portion in the gravity direction (the Z direction) of the second flow passage 555b. Stated another way, a portion in the lower portion in the gravity direction (the Z direction) of the second flow passage 555b, for example, a portion below the portion connecting to the first flow passage 555a, functions as the oil trap 558.

Here, a method for manufacturing the relay block 55 according to the embodiment is described with reference to FIG. 9.

As an example, the inflow-port side connection unit 551 and the third flow passage 555c (the inflow side flow passage 555) are formed by cutting out a non-through-hole in the +X direction from one surface (a Y-Z plane on the −X side) of the relay block 55. Note that the third flow passage 555c (the inflow side flow passage 555) may be formed by cutting out a hole that penetrates from one surface (any of the Y-Z planes) of the relay block 55 to the other side in the X direction, and inserting a sealing member such as a screw on the +X side.

As an example, the relay-block side inflow port 553 and the first flow passage 555a (the inflow side flow passage 555) are formed by cutting out a non-through-hole in the −X direction from one surface (a Y-Z plane on the +X side) of the relay block 55. Note that the first flow passage 555a (the inflow side flow passage 555) may be formed by cutting out a hole that penetrates from one surface (any of the Y-Z planes) of the relay block 55 to the other side in the X direction, and inserting a sealing member such as a screw on the −X side.

As an example, the second flow passage 555b (the inflow side flow passage 555) is formed by cutting out a non-through-hole in the +Z direction from a lower side (an X-Y plane on the −Z side) in the gravity direction of the relay block 55, and inserting a sealing member such as a screw on the lower side (the −Z side). Note that the second flow passage 555b (the inflow side flow passage 555) may be formed by cutting out a non-through-hole in the −Z direction from an upper side (an X-Y plane on the +Z side) of the relay block 55, and inserting a sealing member such as a screw on the upper side (the +Z side). Furthermore, the second flow passage 555b (the inflow side flow passage 555) may be formed by cutting out a hole that penetrates from one surface (any of the X-Y planes) of the relay block 55 to the other side in the Z direction, and inserting a sealing member such as a screw on both sides in the gravity direction (the Z direction).

As an example, the outflow-port side connection unit 552, the relay-block side outflow port 554, and the outflow side flow passage 556 are formed by cutting out a hole that penetrates from any one surface (a Y-Z plane) of the relay block 55 to the other side in the X direction.

As an example, the return pipe 557 is formed by cutting out a non-through-hole in the Y direction from one surface (any of the Z-X planes) of the relay block 55, and inserting a sealing member such as a screw on the cut-out side. Note that the return pipe 557 may be formed by cutting out a hole that penetrates from one surface (any of the Z-X planes) of the relay block 55 to the other side in the Y direction, and inserting a sealing member such as a screw on both sides in a direction of cutting-out (the Y direction).

Note that a case where the relay block 55 is formed by cutting has been described as an example, but this is not restrictive. The relay block 55 may be formed by using casting or a 3D printer.

As described above, the relay block 55 can recirculate oil from an inflow side of the cooling plate 4 to an outflow side of the cooling plate 4, by using the return pipe 557 that bypasses the inflow side and the outflow side inside the relay block 55. Stated another way, by employing the cooling system 1 to which the oil accumulation eliminating device 5 according to the present embodiment, inside the relay block 55, oil is sucked out from the inflow side of the cooling plate 4 to the outflow side of the cooling plate 4, and this can reduce an amount of compressor oil that flows into the flow passage 43 via the inflow port 41 of the cooling plate 4. Stated another way, the cooling system 1 according to the embodiment can prevent compressor oil that circulates together with the refrigerant from being stagnant inside the cooling plate 4.

Furthermore, by employing the cooling system 1 according to the present embodiment, in applying the oil accumulation eliminating device 5, it is sufficient if a relay block 55 that corresponds to shapes of the inflow and outflow ports of the cooling plate 4 is prepared, and processing on the cooling plate 4 can be omitted. This enables the oil accumulation eliminating device 5 to be easily applied to an existing cooling plate 4.

According to at least one embodiment described above, compressor oil that circulates together with the refrigerant can be prevented from being stagnant inside the cooling plate 4.

According to the present disclosure, the compressor oil that circulates together with the refrigerant can be prevented from being stagnant inside the cooling plate. Note that the advantageous effect described here is not necessarily restrictive, and any of the advantageous effects described herein may be exhibited.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### Supplementary Notes

The description above of the embodiments discloses the technique described below.

(1)

An oil accumulation eliminating device including:
a cooling plate that includes
   a housing that is thermally connected to a heat dissipation target,
   an inflow port that is connected to high-pressure side piping in an air-conditioning system through which a refrigerant circulates, and supplied with the refrigerant from the high-pressure side piping,
   a flow passage that is formed inside the housing, and though which the refrigerant that has flowed in from the inflow port flows, and
   an outflow port that is connected to low-pressure side piping of the air-conditioning system, and ejects, to the low-pressure side piping, the refrigerant that has exchanged heat with the housing in the flow passage; and
a return pipe that spatially connects, outside the housing of the cooling plate, the inflow port and the outflow port of the cooling plate by using a flow passage section that is smaller than flow passage sections of the inflow port and the outflow port.
   (2)

The oil accumulation eliminating device according to (1) described above, wherein
at least a portion of the return pipe has a flow passage section decreasing toward the outflow port from the inflow port.
   (3)

The oil accumulation eliminating device according to (1) described above, wherein
the flow passage section of the flow passage has a shape different from the inflow port and the outflow port.
   (4)

The oil accumulation eliminating device according to any one of (1) to (3) described above, wherein
a length by which the inflow port protrudes from the housing is greater than a length by which the outflow port protrudes from the housing, and
the return pipe spatially connects a hole provided in a portion that protrudes from the housing in the inflow port to the hole provided in a portion that protrudes from the housing in the outflow port.
   (5)

The oil accumulation eliminating device according to (4) described above, wherein
the return pipe includes:
   an oil trap that is provided below the hole that is provided in a lower portion in a gravity direction in the portion that protrudes from the housing in the inflow port, the oil trap being spatially connected to the hole of the inflow port; and
   a pipe line that spatially connects the oil trap to the hole that is provided in the portion that protrudes from the housing in the outflow port.
      (6)

The oil accumulation eliminating device according to (5) described above, wherein
the oil trap is formed by a pipe line that extends downward from the hole that is provided in the lower portion in the gravity direction in the inflow port.
   (7)

The oil accumulation eliminating device according to (5) described above, wherein
the pipe line spatially connects a lower portion in the gravity direction in the oil trap to the hole of the outflow port.
   (8)

The oil accumulation eliminating device according to (5) described above, wherein
the pipe line has a flow passage section decreasing toward the outflow port from the oil trap.
   (9)

The oil accumulation eliminating device according to any one of (1) to (3) described above, further including
a relay block inside which
   an inflow side flow passage that spatially connects the high-pressure side piping to the inflow port;
   an outflow side flow passage that spatially connects the outflow port to the low-pressure side piping; and
   the return pipe that spatially connects a hole that is provided in the inflow side flow passage to a hole that is provided in the outflow side flow passage
are formed.
   (10)

The oil accumulation eliminating device according to (9) described above, wherein
the inflow side flow passage includes:
   a first flow passage that extends from a portion connecting with the high-pressure side piping toward the inflow port;
   a second flow passage that is spatially connected to the first flow passage, and extends upward and downward in a gravity direction from a portion connecting with the first flow passage; and
   a third flow passage that is spatially connected to an upper portion in the gravity direction in the second flow passage, and extends from a portion connecting with the second flow passage to a portion connecting with the inflow port, and
the return pipe spatially connects the hole that is provided below the portion connecting with the first flow passage in the gravity direction in the second flow passage to the hole of the outflow side flow passage.
   (11)

The oil accumulation eliminating device according to (10) described above, wherein
in the second flow passage of the inflow side flow passage, a portion below the portion connecting with the first flow passage in the gravity direction forms an oil trap.
   (12)

The oil accumulation eliminating device according to (10) described above, wherein
a length by which the inflow port protrudes from the housing is greater than a length by which the outflow port protrudes from the housing,
the third flow passage of the inflow side flow passage is formed above the first flow passage of the inflow side flow passage in the gravity direction, and
the first flow passage of the inflow side flow passage is formed above the outflow side flow passage in the gravity direction.
   (13)

An oil accumulation eliminating device including:
a relay block inside which
   a return pipe that spatially connects, outside a housing of a cooling plate, an inflow port and an outflow port of the cooling plate by using a flow passage section that is smaller than flow passage sections of the inflow port and the outflow port, the cooling plate including: the housing that is thermally connected to a heat dissipation target; the inflow port that is connected to high-pressure side piping in an air-conditioning system through which a refrigerant circulates, and supplied with the refrigerant from the high-pressure side piping; a flow passage that is formed inside the housing, and through which the refrigerant that has flowed in from the inflow port flows; and the outflow port that is connected to low-pressure side piping of the air-conditioning system, and ejects, to the low-pressure side piping, the refrigerant that has exchanged heat with the housing in the flow passage,
   an inflow side flow passage that spatially connects the high-pressure side piping to the inflow port, and
   an outflow side flow passage that spatially connects the outflow port to the low-pressure side piping
are formed, in which
the return pipe spatially connects a hole that is provided in the inflow side flow passage to a hole that is provided in the outflow side flow passage.
   (14)

A coil device (a power conversion device or an on-board charger) including:
the oil accumulation eliminating device (a cooling device) according to any one of (1) to (12) described above; and
a power converter that includes a plurality of electronic components including a magnetic component, converts, into direct current power, alternating current power supplied from an external single-phase or three-phase alternating current power supply, and outputs the direct current power after conversion.
   (15)

A coil device (a power conversion device or a DCDC converter) including:
the oil accumulation eliminating device (a cooling device) according to any one of (1) to (12) described above; and
a power converter that includes a plurality of electronic components including a magnetic component, converts direct current power that has been input, into the direct current power having a predetermined voltage value, and outputs the direct current power after conversion.
   (16)

A vehicle including:
the coil device according to (14) or (15) described above; and
a battery that is charged by using the direct current power after conversion performed by the coil device.

What is claimed is:

1. An oil accumulation eliminating device comprising:
a cooling plate that includes
a housing that is thermally connected to a heat dissipation target,
an inflow port that is connected to high-pressure side piping in an air-conditioning system through which a refrigerant circulates, and supplied with the refrigerant from the high-pressure side piping,
a flow passage that is formed inside the housing, and though which the refrigerant that has flowed in from the inflow port flows, and
an outflow port that is connected to low-pressure side piping of the air-conditioning system, and ejects, to the low-pressure side piping, the refrigerant that has exchanged heat with the housing in the flow passage; and
a return pipe that spatially connects, outside the housing of the cooling plate, the inflow port and the outflow port of the cooling plate by using a flow passage section that is smaller than flow passage sections of the inflow port and the outflow port.

2. The oil accumulation eliminating device according to claim 1, wherein
at least a portion of the return pipe has a flow passage section decreasing toward the outflow port from the inflow port.

3. The oil accumulation eliminating device according to claim 1, wherein
the flow passage section of the flow passage has a shape different from the inflow port and the outflow port.

4. The oil accumulation eliminating device according to claim 1, wherein
a length by which the inflow port protrudes from the housing is greater than a length by which the outflow port protrudes from the housing, and
the return pipe spatially connects a hole provided in a portion that protrudes from the housing in the inflow port to the hole provided in a portion that protrudes from the housing in the outflow port.

5. The oil accumulation eliminating device according to claim 4, wherein
the return pipe includes:
an oil trap that is provided below the hole that is provided in a lower portion in a gravity direction in the portion that protrudes from the housing in the inflow port, the oil trap being spatially connected to the hole of the inflow port; and
a pipe line that spatially connects the oil trap to the hole that is provided in the portion that protrudes from the housing in the outflow port.

6. The oil accumulation eliminating device according to claim 5, wherein
the oil trap is formed by a pipe line that extends downward from the hole that is provided in the lower portion in the gravity direction in the inflow port.

7. The oil accumulation eliminating device according to claim 5, wherein
the pipe line spatially connects a lower portion in the gravity direction in the oil trap to the hole of the outflow port.

8. The oil accumulation eliminating device according to claim 5, wherein
the pipe line has a flow passage section decreasing toward the outflow port from the oil trap.

9. The oil accumulation eliminating device according to claim 1, further comprising
a relay block inside which
an inflow side flow passage that spatially connects the high-pressure side piping to the inflow port;
an outflow side flow passage that spatially connects the outflow port to the low-pressure side piping; and
the return pipe that spatially connects a hole that is provided in the inflow side flow passage to a hole that is provided in the outflow side flow passage
are formed.

10. The oil accumulation eliminating device according to claim 9, wherein
the inflow side flow passage includes:
a first flow passage that extends from a portion connecting with the high-pressure side piping toward the inflow port;
a second flow passage that is spatially connected to the first flow passage, and extends upward and downward in a gravity direction from a portion connecting with the first flow passage; and
a third flow passage that is spatially connected to an upper portion in the gravity direction in the second flow passage, and extends from a portion connecting with the second flow passage to a portion connecting with the inflow port, and
the return pipe spatially connects the hole that is provided below the portion connecting with the first flow passage in the gravity direction in the second flow passage to the hole of the outflow side flow passage.

11. The oil accumulation eliminating device according to claim 10, wherein
in the second flow passage of the inflow side flow passage, a portion below the portion connecting with the first flow passage in the gravity direction forms an oil trap.

12. The oil accumulation eliminating device according to claim 10, wherein
a length by which the inflow port protrudes from the housing is greater than a length by which the outflow port protrudes from the housing,
the third flow passage of the inflow side flow passage is formed above the first flow passage of the inflow side flow passage in the gravity direction, and
the first flow passage of the inflow side flow passage is formed above the outflow side flow passage in the gravity direction.
